(19) United States
(12) Patent Application Publication
(10) Pub. No.: US 2012/0247292 A1
(43) Pub. Date: Oct. 4, 2012

(54) CUTTING APPARATUS, CUTTING DATA PROCESSING DEVICE AND COMPUTER-READABLE STORAGE MEDIUM STORING CUTTING CONTROL PROGRAM THEREFOR

(75) Inventors: Yasuhiko Kawaguchi, Nagoya-shi (JP); Yoshinori Nakamura, Toyohashi-shi (JP); Masahiko Nagai, Nagoya-shi (JP); Tomoyasu Niizeki, Ichinomiya-shi (JP); Katsuhisa Hasegawa, Kasugai-shi (JP)

(73) Assignee: BROTHER KOGYO KABUSHIKI KAISHA, Nagoya-shi (JP)

(21) Appl. No.: 13/429,963

(22) Filed: Mar. 26, 2012

(30) Foreign Application Priority Data
Mar. 30, 2011 (JP) 2011-075578

(51) Int. Cl. B26D 5/02

(52) U.S. Cl. 83/76.1

(57) ABSTRACT

A cutting apparatus moves a cutting blade and in object to be cut relative to each other based on cutting data, thereby cutting a desirable pattern out of the object. The cutting apparatus includes an extraction unit which extracts from the cutting data a position of a cutting start point and a position of a cutting end point of a cutting line on the object, and a setting unit which changes the positions of the cutting start and end points to a position on the cutting line other than a specified position on the cutting line when the positions of the cutting start and end points extracted by the extraction unit are on the specified position in a case where a closed pattern having the cutting start and endpoints corresponding with each other is cut out of the object.

### CROSS-REFERENCE TO RELATED APPLICATIONS

This application is based upon and claims the benefit of priority from the prior Japanese Patent Application No. 2011-075578 filed on Mar. 30, 2011, the entire contents of which are incorporated herein by reference.

### BACKGROUND

1. Technical Field

The present disclosure relates to a cutting apparatus in which a cutting blade and an object to be cut are moved relative to each other based on cutting data so that a desired pattern is cut out of the object, a cutting data processing device which processes the cutting data for the cutting apparatus and a computer-readable storage medium storing a cutting control program on which the cutting apparatus is operable.

2. Related Art

There has conventionally been known a cutting plotter which automatically cuts a sheet such as paper based on cutting data, for example. In the cutting plotter, a sheet such as paper is inserted between rollers of a drive mechanism from above and below thereby to be held therebetween. The sheet is then moved in a first direction while being held in the aforementioned manner and a carriage with a cutting blade is moved in a second direction perpendicular to the first direction, thereby cutting the sheet.

For example, when a rectangular shape is cut out of the sheet, a blade edge of the cutting blade is pressed against an apex serving as a cutting start point on the sheet. In this state, the sheet and the cutting blade are moved in the respective first and second directions relative to each other so as to trace a cutting line of four sides of the rectangle. The cutting blade is separated from the sheet when having reached the aforesaid apex which also serves as a cutting end point as well as the cutting start point. When a closed shape having the cutting start and end points corresponding with each other is cut, there is a case where a part between the cutting start and end points sometimes remains uncut due to the accuracy in the positioning of the cutting blade. The material of the sheet sometimes results in an uncut part between the cutting start and end points.

In view of the foregoing problem, a cutting control manner has been suggested in which cutting data is corrected so that cutting starts on an extension in a direction opposed to the cutting direction from the cutting start point and is continued over the cutting end point. In this cutting control manner, the sheet is excessively cut both at the time of cutting start and at the time of cutting end, whereupon the sheet can be cut without uncut part. The cutting start and end points are normally set at an apex of neighboring line segments of the cutting line as described above, that is, at a specified position such as an intersection of sides of a polygon when the cutting line is rectangular or polygonal in shape.

However, since the sheet is excessively cut at both cutting start and end points, the above-described cutting control manner results in the following technical problem. For example, when a rectangular pattern is cut out of the sheet, cutting starts outside the rectangular pattern at the time of cutting start. At the time of cutting end, the sheet is excessively cut outside over the cutting start point. As a result, when a remaining part of the sheet without a cut rectangular, pattern is used as a finished product, the finished product has an excessive cutout, which entails a problem.

### SUMMARY

Therefore, an object of the disclosure is to provide a cutting apparatus which can cut the object without excessive cutting and without uncut part, a cutting data processing device for the cutting apparatus, and a computer-readable storage medium storing a cutting data processing program.

The present disclosure provides a cutting apparatus which moves a cutting blade and in object to be cut relative to each other based on cutting data, thereby cutting a desirable pattern out of the object, the cutting apparatus comprising an extraction unit which extracts from the cutting data a position of a cutting start point and a position of a cutting end point of a cutting line on the object; and a setting unit which changes the positions of the cutting start and endpoints to a position on the cutting line other than a specified position on the cutting line when the positions of the cutting start and end points extracted by the extraction unit are on the specified position in a case where a closed pattern having the cutting start and end points corresponding with each other is cut out of the object.

### BRIEF DESCRIPTION OF THE DRAWINGS

In the accompanying drawings:

FIG. 1 is a perspective view of the cutting apparatus according to a first embodiment, showing an inner structure thereof;

FIG. 2 is a plan view of the cutting apparatus;

FIG. 3 is a perspective view of a cutter holder;

FIG. 4 is a front view of the cutter holder, showing the state where a cutter has been descended;

FIG. 5 is a sectional view of the cutter holder, showing the case where the cuter has been ascended;

FIG. 6 is a sectional view taken along lines VI-VI in FIG. 4;

FIG. 7 is an enlarged front view of a gear;

FIG. 8 is an enlarged view of the vicinity of a distal end of the cutter during the cutting;

FIG. 9 is a side view of the vicinity of the cutter holder during the cutting;

FIG. 10 is a block diagram showing an electrical arrangement of the cutting apparatus;

FIGS. 11A and 11B illustrate pre-change and post-change positions of the cutting start point (cutting end point) on the cutting line of the object for the purpose of comparison;

FIGS. 12A and 12B show an enlarged view of a successive obtuse angle region of the cutting line;

FIG. 13 is a flowchart showing an entire processing in the case where the cutting start and end points are changed;

FIG. 14 is a flowchart showing the processing in the case where the cutting start and end points are changed to a middle position on the line segment;

FIG. 15 is a flowchart showing a data sorting process;

FIG. 16 is a flowchart showing the processing in the case where the cutting start and endpoints are changed to a successive obtuse angle region;

FIG. 17 is a flowchart showing a process of setting focused three points;

FIG. 18 is an enlarged view explaining the three points to be counted on the cutting line; and

FIG. 19 is a view similar to FIG. 10, showing a second embodiment.

### DETAILED DESCRIPTION

### First Embodiment

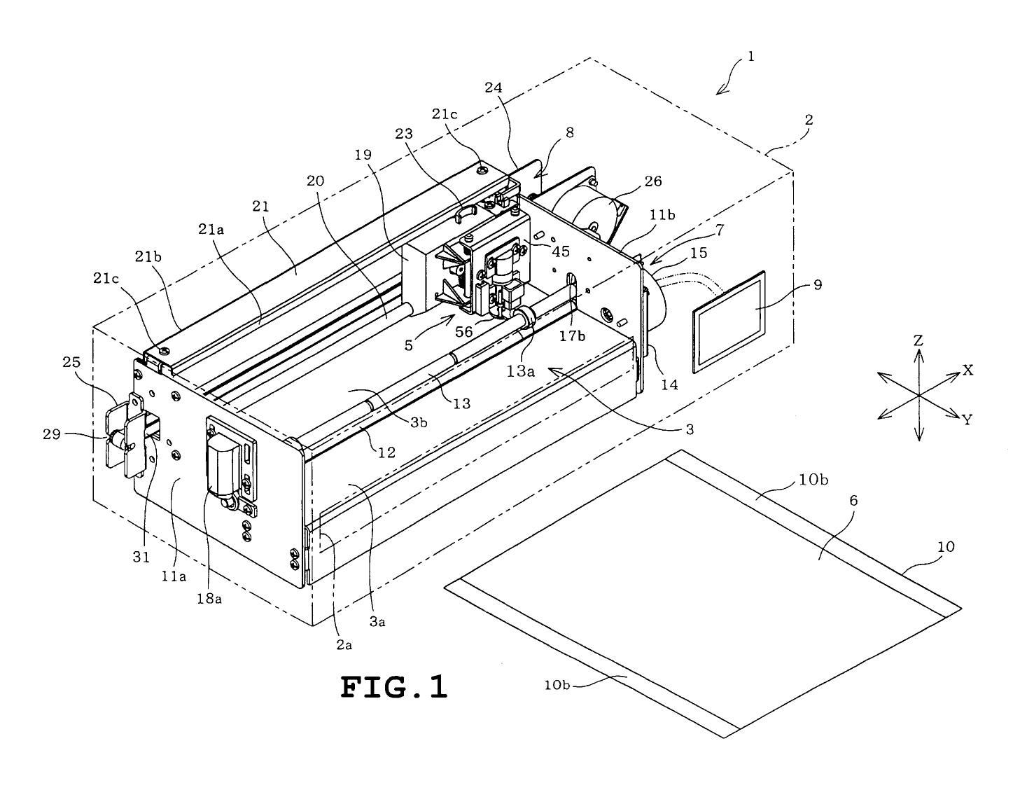

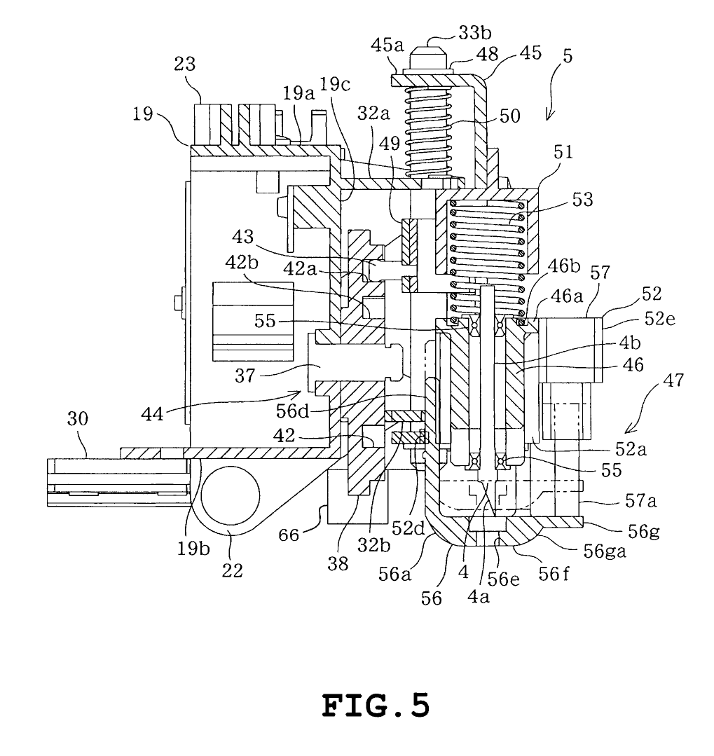

A first embodiment will be described with reference to FIGS. 1 to 18. Referring to FIG. 1, a cutting apparatus 1 includes a body cover 2 as a housing, a platen 3 provided in the body cover 2 and a cutter holder 5 also provided in the body cover 2. The cutting apparatus 1 also includes first and second moving units 7 and 8 for moving a cutter 4 (see FIG. 5) of the cutter holder 5 and an object 6 to be cut, relative to each other. The body cover 2 is formed into the shape of a horizontally long rectangular box and has a front formed with a horizontally long opening 2a which is provided for setting a holding sheet 10 holding the object 6. In the following description, the side where the user who operates the cutting apparatus 1 stands will be referred to as “front” and the opposite side will be referred to as “back.” The front-back direction thereof will be referred to as “Y direction.” The right-left direction perpendicular to the Y direction will be referred to as “X direction.”

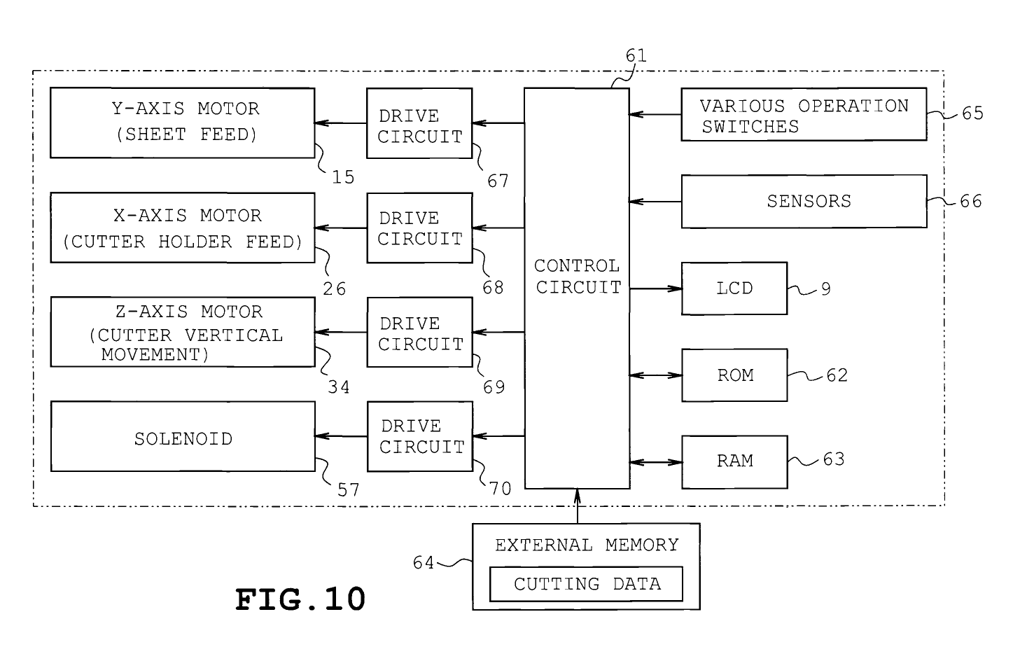

On a right part of the body cover 2 is provided a liquid crystal display (LCD) 9 which serves as a display unit displaying messages and the like necessary for the user. A plurality of operation switches 65 (see FIG. 10) is also provided on the right part of the body cover 2. The platen 3 includes a pair of front and rear plate members 3a and 3b and has an upper surface which is configured into an X-Y plane serving as a horizontal plane. The platen 3 is set so that the holding sheet 10 holding the object 6 is placed thereon. The holding sheet 10 is received by the platen 3 when the object 6 is cut. The holding sheet 10 has an upper surface with an adhesive layer 10a (see FIG. 8) formed by applying an adhesive agent to a part thereof except for right and left edges 10b. The object 6 is affixed to the adhesive layer 10a thereby to be held.

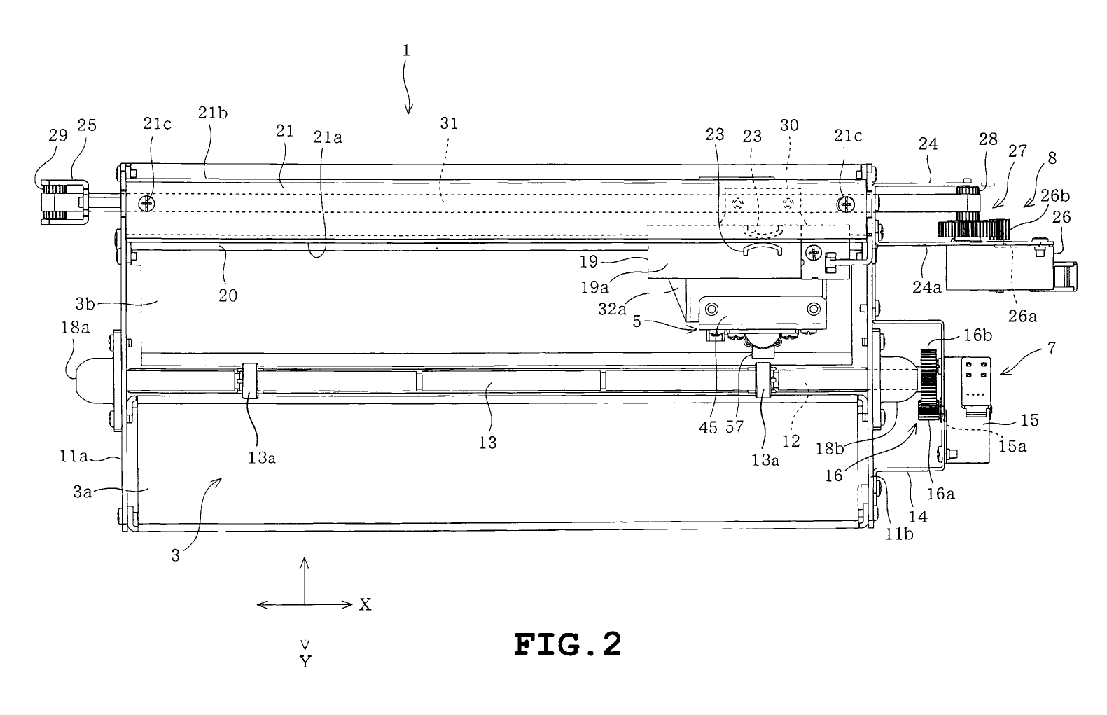

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b of the platen 3. The driving roller 12 and the pinch roller 13 extend in the X direction and are rotatably supported on the sidewalls 11b and 11a. The driving roller 12 and the pinch roller 13 are disposed so as to be parallel to the X-Y plane and so as to be vertically arranged. The driving roller 12 is located lower than the pinch roller 13. A first crank-shaped mounting frame 14 is provided on the right sidewall 11b so as to be located on the right of the driving roller 12 as shown in FIG. 2. A Y-axis motor 15 is fixed to an outer surface of the mounting frame 14. The Y-axis motor 15 comprises a stepping motor, for example and has a rotating shaft 15a extending through the first mounting frame 14 and further has a distal end provided with a gear 16a. The driving roller 12 has a right end to which is secured another gear 16b which is brought into mesh engagement with the gear 16a. These gears 16a and 16b constitute a first reduction gear mechanism 16. The pinch roller 13 is guided by guide grooves 17b formed in the right and left sidewalls 11b and 11a so as to be movable upward and downward. Only the right guide groove 17b is shown in FIG. 1. Two spring accommodating members 18a and 18b are mounted on the right and left sidewalls 11b and 11a in order to cover the guide groove 17b from the outside respectively. The pinch roller 13 is biased downward by compression coil springs (not shown) accommodated in the spring accommodating portions 18a and 18b respectively. The pinch roller 13 is provided with pressing portions 13a which are brought into contact with a left edge 10b and a right edge 10c of the holding sheet 10, thereby pressing the edges 10b and 10c, respectively. Each pressing portion 13a has a slightly larger outer diameter than the other portion of the pinch roller 13.

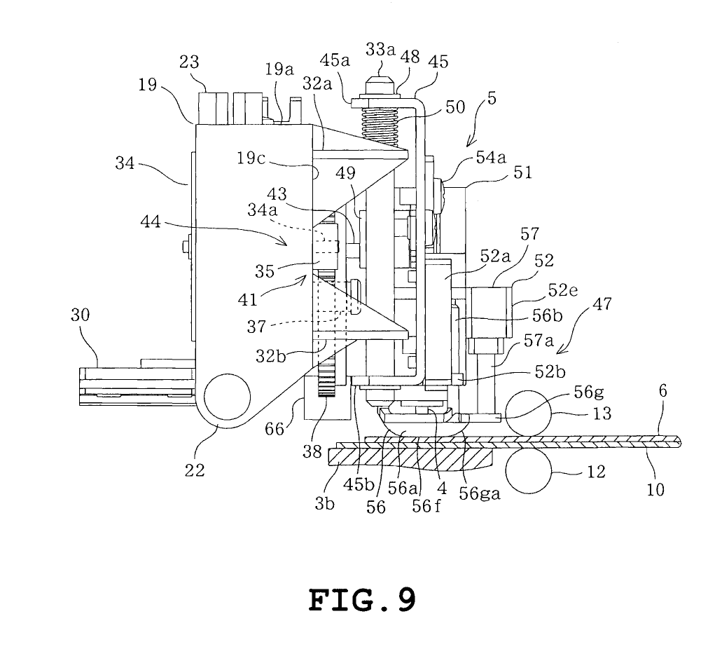

The driving roller 12 and the pinch roller 13 press the holding sheet 10 from below and from above by the urging force of the compression coil springs thereby to hold the holding sheet 10 therebetween (see FIG. 9). Upon drive of the Y-axis motor 15, normal or reverse rotation of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the compression coil springs and the like.

The second moving unit 8 moves a carriage 19 supporting the cutter holder 5 in the X direction (a second direction). The second moving unit 8 will be described in more detail. A guide shaft 20 and a guide frame 21 both extending in the right-left direction are provided between the right and left sidewalls 11b and 11a so as to be located at the rear end of the cutting apparatus 1, as shown in FIGS. 1 and 2. The guide shaft 20 is disposed in parallel with the driving roller 12 and the pinch roller 13. The guide shaft 20 located right above the platen 3 extends through a lower part of the carriage 19 (a through hole 22 as will be described later). The guide frame 21 has a front edge 21a and a rear edge 21b both folded downward such that the guide frame 21 has a generally C-shaped section. The front edge 21a is disposed in parallel with the guide shaft 20. The guide frame 21 is adapted to guide an upper part (guided members 23 as will be described later) of the carriage 19 by the front edge 21a. The guide frame 21 is fixed to upper ends of the sidewalls 11a and 11b by screws 21c respectively.

A second mounting frame 24 is mounted on the right sidewall 11b in the rear of the cutting apparatus 1, and an auxiliary frame 25 is mounted on the left sidewall 11a in the rear of the cutting apparatus 1, as shown in FIG. 2. An X-axis motor 26 and a second reduction gear mechanism 27 are provided on the second mounting frame 24. The X-axis motor 26 comprises a stepping motor, for example and is fixed to a front of a front mounting piece 24a. The X-axis motor 26 includes a rotating shaft 26a which extends through the mounting piece 24a and has a distal end provided with a gear 26b which is brought into mesh engagement with the second reduction gear mechanism 27. A pulley 28 is rotatably mounted on the second reduction gear mechanism 27, and another pulley 29 is rotatably mounted on the left auxiliary frame 25 as viewed in FIG. 2. An endless timing belt 31 connected to a rear end (a mounting portion 30 as will be described later) of the carriage 19 extends between the pulleys 28 and 29.

Upon drive of the X-axis motor 26, normal or reverse rotation of the X-axis motor 26 is transmitted via the second reduction gear mechanism 27 and the pulley 28 to the timing belt 31, whereby the carriage 19 is moved leftward or rightward together with the cutter holder 5. Thus, the carriage 19 and the cutter holder 5 are moved in the X direction perpendicular to the Y direction in which the object 6 is conveyed. The second moving unit 8 is constituted by the above-described guide shaft 20, the guide frame 21, the X-axis motor 26, the second reduction gear mechanism 27, the pulleys 28 and 29, the timing belt 31, the carriage 19 and the like.

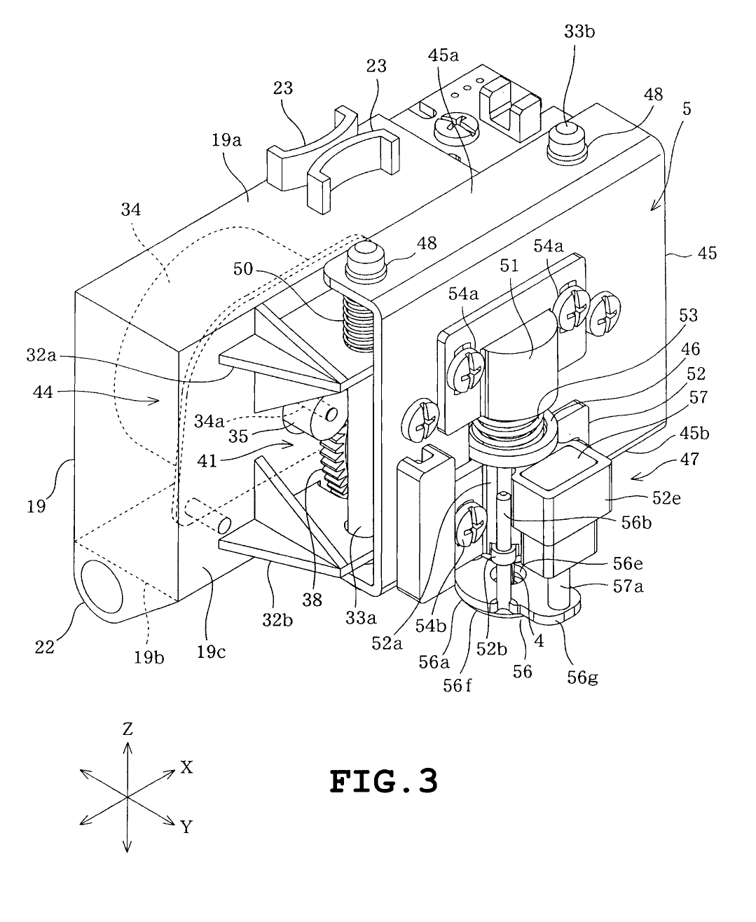

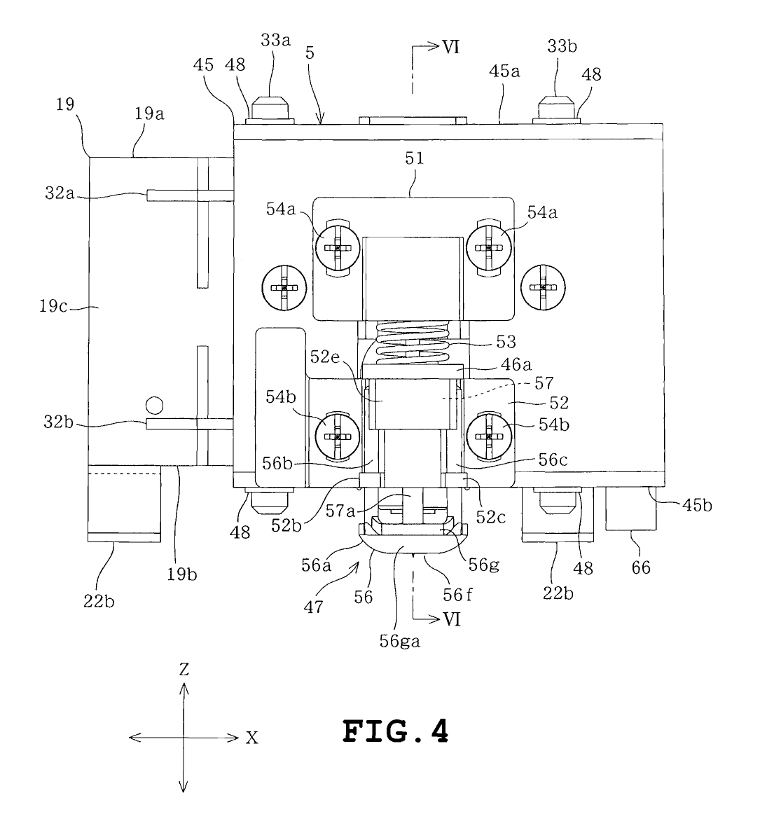

The cutter holder 5 is disposed on the front of the carriage 19 and is supported so as to be movable in a vertical direction (a third direction) serving as a Z direction. The carriage 19 and the cutter holder 5 will be described with reference to FIGS. 3 to 7 as well as FIGS. 1 and 2. The carriage 19 is formed into the shape of a substantially rectangular box with an open rear as shown in FIGS. 2 and 3. The carriage 19 has an upper wall 19a with which a pair of upwardly protruding front and rear guided members 23 are integrally formed. The guided members 23 are arc-shaped ribs as viewed in a planar view. The guided members 23 are symmetrically disposed with a front edge 21a of the guide frame 21 being interposed therebetween. The carriage 19 has a bottom wall 19b further having a downwardly expanding portion which is formed with a pair of right and left through holes 22 through which the guide shaft 20 is inserted, as shown in FIG. 4. An attaching portion 30 (see FIGS. 5 and 9) is mounted on the bottom wall 19b of the carriage 19 so as to protrude rearward. The attaching portion 30 is to be, coupled with the timing belt 31. The carriage 19 is thus supported by the guide shaft 20 inserted through the holes 22 so as to be slidable in the right-left direction and further supported by the guide frame 21 held between the guided members 23 so as to be prevented from being rotated about the guide shaft 20.

The carriage 19 has a front wall 19c with which a pair of upper and lower support portions 32a and 32b are formed so as to extend forward as shown in FIGS. 3 to 5, 9, etc. A pair of right and left support shafts 33b and 33a extending through the respective support portions 32a and 32b are mounted on the carriage 19 so as to be vertically movable. A Z-axis motor 34 comprising, for example, a stepping motor is accommodated in the carriage 19 backward thereby to be housed therein. The Z-axis motor 34 has a rotating shaft 34a (see FIGS. 3 and 9) which extends through the front wall 19c of the carriage 19. The rotating shaft 34a has a distal end provided with a gear 35. Furthermore, the carriage 19 is provided with a gear shaft 37 which extends through a slightly lower part of the gear 35 relative to the central part of the front wall 19c as shown in FIGS. 5, 6 and 9. A gear 38 is rotatably mounted on the gear shaft 37 and adapted to be brought into mesh engagement with the gear 35 in front of the front wall 19c is rotatably mounted on the gear shaft 37. The gear 38 is retained by a retaining ring (not shown) mounted on a front end of the gear shaft 37. The gears 35 and 38 constitute a third reduction mechanism 41 (see FIGS. 3 and 9).

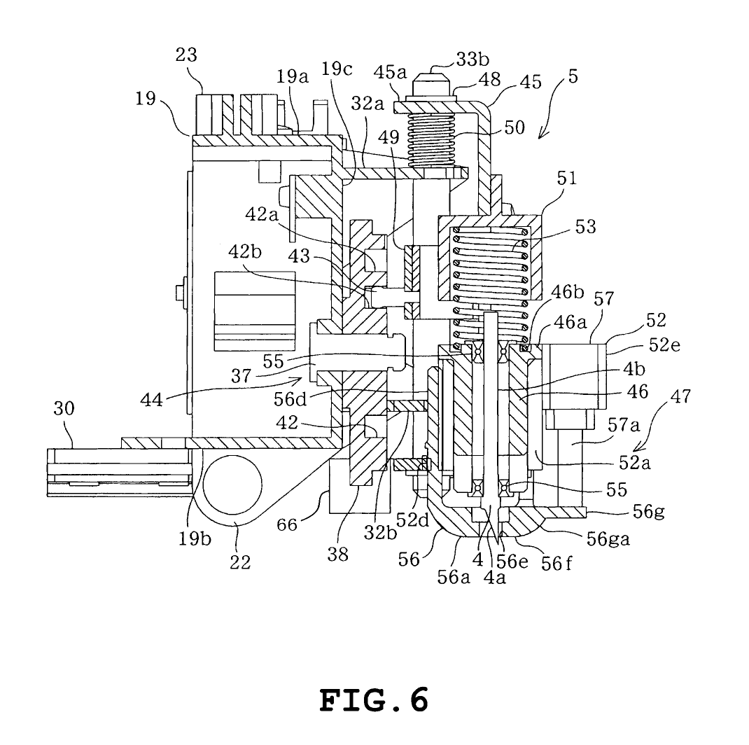

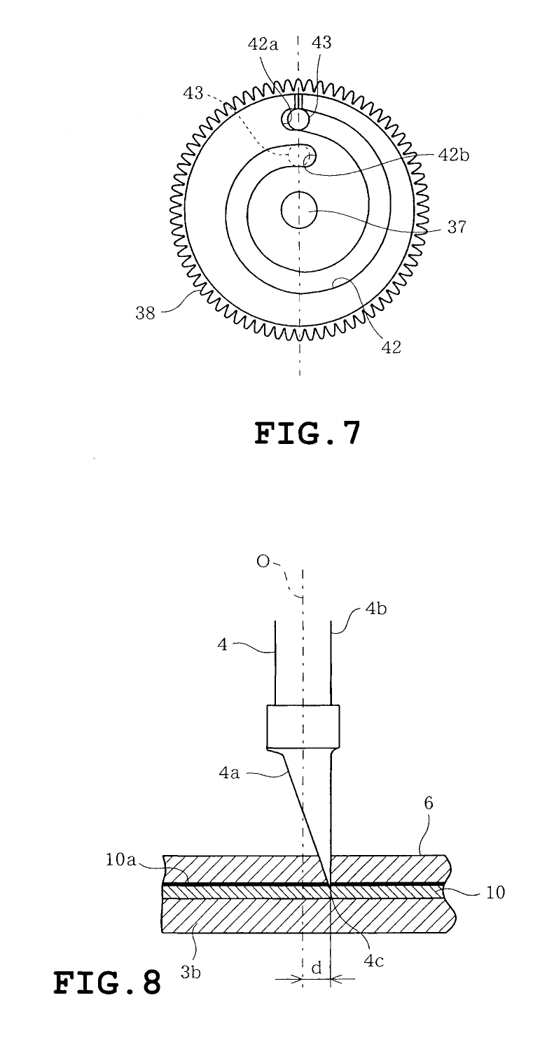

The gear 38 is formed with a spiral groove 42 as shown in FIG. 7. The spiral groove 42 is a cam groove formed into a spiral shape such that the spiral groove 42 comes closer to the center of the gear 38 as it is turned rightward from a first end 42a toward a second end 42b. An engagement pin 43 which is vertically moved together with the cutter holder 5 engages the spiral groove 42 (see FIGS. 5 and 6) as will be described in detail later. Upon normal or reverse rotation of the Z-axis motor 34, the gear 38 is rotated via the gear 35. Rotation of the gear 38 vertically slides the engagement pin 43 in engagement with the spiral groove 42. With the vertical slide of the gear 38, the cutter holder 5 is moved upward or downward together with the support shafts 33a and 33b. In this case, the cutter holder 5 is moved between a raised position (see FIGS. 5 and 7) where the engagement pin 43 is located at the first end 42a of the spiral groove 42 and a lowered position (see FIGS. 6 and 7) where the engagement pin 43 is located at the second end 42b. A third moving unit 44 which moves the cutter holder 5 upward and downward is constituted by the above-described third reduction mechanism 41 having the spiral groove 42, the Z-axis motor 34, the engagement pin 43, the support portions 32a and 32b, the support shafts 33a and 33b, etc.

The cutter holder 5 includes a holder body 45 provided on the support shafts 33a and 33b, a movable cylindrical portion 46 which has a cutter 4 (a cutting blade) and is held by the holder body 45 so as to be vertically movable and a pressing device 47 which presses the object 6. More specifically, the holder body 45 has an upper end 45a and a lower end 45b both of which are folded rearward such that the holder body 45 is generally formed into a C-shape, as shown in FIGS. 3 to 5, 9 and the like. The upper and lower ends 45a and 45b are immovably fixed to the support shafts 33a and 33b by retaining rings 48 fixed to upper and lower ends of the support shafts 33a and 33b, respectively. The support shaft 33b has a middle part to which is secured a coupling member 49 provided with a rearwardly directed engagement pin 43 as shown in FIGS. 5 and 6. The holder body 45, support shafts 33a and 33b, the engagement pin 43 and the coupling member 40 are formed integrally with one another as shown in FIGS. 5 and 6. The cutter holder 5 is vertically moved by the third moving unit 44 in conjunction with the engagement pin 43. Furthermore, compression coil springs 50 serving as biasing members are mounted about the support shafts 33a and 33b so as to be located between upper surfaces of the support portion and upper end of the holder body 45, respectively. The entire cutter holder 5 is elastically biased upward by a biasing force of the compression coil springs 50 relative to the carriage 19.

Mounting members 51 and 52 provided for mounting the movable cylindrical portion 46, the pressing device 47 and the like are fixed to the middle portion of the holder body 45 by screws 54a and 54b respectively, as shown in FIGS. 3 and 4. The lower mounting member 52 is provided with a cylindrical portion 52a (see FIG. 5) which supports the movable cylindrical portion 46 so that the movable cylindrical portion 46 is vertically movable. The movable cylindrical portion 46 has a diameter that is set so that the movable cylindrical portion 46 is brought into a sliding contact with the inner peripheral surface of the cylindrical portion 52a. The movable cylindrical portion 46 has an upper end on which a flange 46a supported on an upper end of the cylindrical portion 52a is formed so as to expand radially outward. A spring shoe 46b is provided on an upper end of the flange 46a. A compression coil spring 53 is interposed between the upper mounting member 51 and the spring shoe 46b of the movable cylindrical portion 46 as shown in FIGS. 5 and 6. The compression coil spring 53 biases the movable cylindrical portion 46 (the cutter 4) to the lower object 6 side while allowing the upward movement of the movable cylindrical portion 46 against the biasing force when an upward force acts on the cutter 4.

The cutter 4 is provided in the movable cylindrical portion 46 so as to extend therethrough in the axial direction. In more detail, the cutter 4 has a round bar-like cutter shaft 4b which is longer than the movable cylindrical portion 46 and a blade 4a integrally formed on a lower end of the cutter shaft 4b. The blade 4a is formed into a substantially triangular shape and has a lowermost blade edge 4c formed at a location offset by a distance d from a central axis 0 of the cutter shaft 4b, as shown in FIG. 8. The cutter 4 is held by bearings 55 (see FIG. 5) mounted on upper and lower ends of the movable cylindrical portion 46 so as to be rotatably movable about the central axis 4z (the Z axis) in the vertical direction. Thus, the blade edge 4c of the cutter 4 presses an X-Y plane or the surface of the object 6 from the Z direction perpendicular to the X-Y plane. Furthermore, the cutter 4 has a height that is set so that when the cutter holder 5 has been moved to a lowered position, the blade edge 4c passes through the object 6 on the holding sheet 10 but does not reach the upper surface of the plate member 3b of the platen 3, as shown in FIG. 8. On the other hand, the blade edge 4c of the cutter 4 is moved upward with movement of the cutter holder 5 to the raised position, thereby being spaced from the object 6 (see FIG. 5).

Three guide holes 52b, 52c and 52d (see FIGS. 3 to 5 and 9) are formed at regular intervals in a circumferential edge of the lower end of the cylindrical portion 52a. A pressing member 56 is disposed under the cylindrical portion 52a and has three guide bars 56b, 56c and 56d which are to be inserted into the guide holes 52b to 52d respectively. The pressing member 56 includes a lower part serving as a shallow bowl-shaped pressing portion body 56a. The aforementioned equally-spaced guide bars 56b to 56d are formed integrally on the circumferential end of the top of the pressing portion body 56a. The guide bars 56b to 56d are guided by the respective guide holes 52b to 52d, so that the pressing member 56 is vertically movable. The pressing portion body 56a has a central part formed with a through hole 56e which vertically extends to cause the blade 4a to pass therethrough. The pressing portion body 56a has an underside serving as a contact portion 56f which is brought into contact with the object 6 while the blade 4a is located in the hole 56e. The contact portion 56.f is formed into an annular horizontal flat surface and is brought into surface contact with the object 6. The contact portion 56f is made of a fluorine resin such as Teflon® so as to have a lower coefficient of friction, whereupon the contact portion 56f is rendered slippery relative to the object 6.

The pressing portion body 56a has a guide 56g which is formed integrally on the circumferential edge thereof so as to extend forward, as shown in FIGS. 3 to 5 and 9. The guide 56g is located in front of and above the contact portion 56f and includes an inclined surface 56ga inclined rearwardly downward to the contact portion 56f side. Consequently, when the holding sheet 10 holding the object 6 is moved rearward relative to the cutter holder 5, the object 6 is guided downward by the guide 56g so as not to be caught by the contact portion 56f.

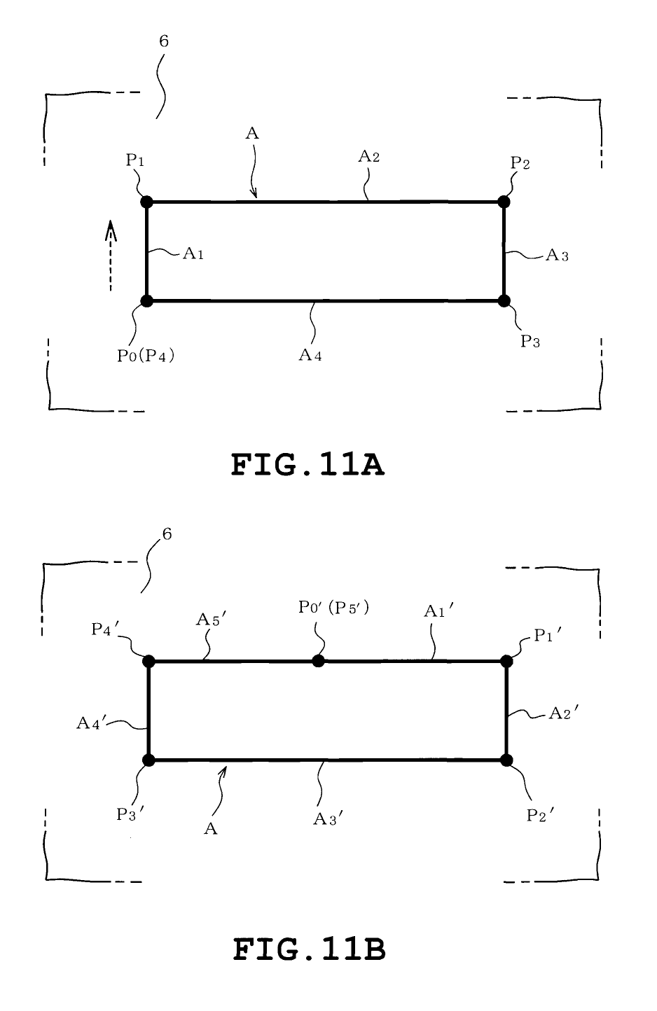

The mounting member 52 has a front mounting portion 52e for the solenoid 57, integrally formed therewith. The front mounting portion 52e is located in front of the cylindrical portion 52a and above the guide 56g. The solenoid 57 serves as an actuator for vertically moving the pressing member 56 thereby to press the object 6 and constitutes a pressing device 47 (a pressing unit) together with the pressing member 56 and a control circuit 61 which will be described later. The solenoid 57 is mounted on the front mounting portion 52e so as to be directed downward. The solenoid 57 includes a plunger 57a having a distal end fixed to the upper surface of the guide 56g. When the solenoid 57 is driven with the cutter holder 5 occupying the lowered position, the pressing member 56 is moved downward together with the plunger 57a thereby to press the object 6 with a predetermined pressure (see FIG. 11). On the other hand, when the plunger 57a is located above during non-drive of the solenoid 57, the pressing member releases the object 6 from application of the pressing force. When the cutter holder 5 is moved to the raised position during non-drive of the solenoid 57 (see two-dot chain line in FIG. 5), the pressing member 56 is completely spaced from the object 6.

The holding sheet 10 has an adhesive layer 10a (see FIG. 8) which holds the object 6. The object 6 is immovably held on the holding sheet 10 by a resultant force of adhesion of the adhesive layer 10a and a pressing force of the pressing device 47. The configurations of the holding sheet 10 and the pressing device 47 will now be described with additional reference to FIGS. 8 and 9. The holding sheet 10 is made of, for example, a synthetic resin and formed into a flat rectangular plate shape, as shown in FIG. 1. The holding sheet 10 is placed opposite the cutter 4 and has a side (aside opposite the cutter 4) on which an adhesive layer 10a (see FIG. 8) is formed by applying an adhesive agent to the holding sheet 10. The sheet-like object 6 such as paper, cloth, resin film or the like is removably held by the adhesive layer 10a. The adhesive layer 10a has an adhesion that is set to a small value such that the object 6 can easily be removed from the adhesive layer 10a without breakage of the object 6.

The arrangement of the control system of the cutting apparatus 1 will now be described with reference to a block diagram of FIG. 10. A control circuit (a control unit) 61 controlling the entire cutting apparatus 1 mainly comprises a computer (CPU). A ROM 62, a RAM 63 and an external memory 64 each serving as a storage unit are connected to the control circuit 61. The ROM 62 stores a cutting control program for controlling the cutting operation, a cutting data processing program and the like. The RAM 63 is provided with storage areas for temporarily storing various data and program necessary for execution of each processing. The external memory 64 stores plurality of types of cutting data.

Operation signals are supplied from the various operation switches 65 to the control circuit 61. The control circuit 61 controls a displaying operation of the LCD 9. In this case, while viewing the displayed contents of the LCD 9, the user operates the switches 65 to select and designate pattern cutting data of a desired pattern. Detection signals are also supplied from various sensors 66 such as a sensor for detecting the holding sheet 10 set from the opening 2a of the cutting apparatus 1. The control circuit 61 is connected to drive circuits 67 to 70 driving the Y-axis, X-axis and Z-axis motors 15, 26 and 34 and the solenoid 57. Upon execution of the cutting control program, the control circuit 61 controls various actuators such as the Y-axis, X-axis and Z-axis motors 15, 26 and 34 and the solenoid 57, based on the pattern cutting data and frame cutting data as will be described later, whereby the cutting operation is automatically executed for the object 6 on the holding sheet 10.

The cutting data includes coordinate point data which indicates an apex of the cutting line composed of a plurality of line segments in the form of X-Y coordinate. More specifically, assume now that a “rectangle” is cut out of the object 6, as shown in FIG. 11A. Symbols P₀ to P₃ designate four apexes of the rectangle respectively. Symbol P₀ serves as a cutting start point and symbol P₄ serves as a cutting endpoint. A rectangular cutting line A includes line segments A1 to A4 constituting a closed cutting line in which the cutting start and end points P₀ and P₄ correspond with each other. The cutting data includes five (n number) coordinate point data including coordinate data corresponding to the cutting start point P₀, the apex P₁, the apex P₂, the apex P₃, and the cutting end point P₄ respectively. When a closed rectangular or polygonal pattern is cut out of the object 6, the cutting start and end points are normally set at specified positions such as an apex neighboring line segments of the cutting line (an intersection of sides, in this case).

The RAM 63 has a data buffer which stores cutting data including the aforementioned n number of coordinate data received from the external memory 64. Thus, the RAM 63 has a storage area in which cutting data is stored, and the storage area is referred to as data buffer in the embodiment. In cutting the object 6 by the cutting apparatus 1, line segments are cut on the basis of cutting data stored by the RAM 63. For example, in the case of cutting line A as shown in FIG. 11A, coordinate point data is stored in the sequence of apexes P₀ to P₄ from the head of data buffer, and line segments A1 to A4 are cut in this sequence. Thus, the cutting start point P₀ is a start point of segment A1 which is initially cut, and the cutting end point P₄ is an end point of line segment A4. The positions of the cutting start and end points P₀ and P₄ correspond with each other. The control circuit 61 serves as an extraction unit which refers to the data buffer of the RAM 63 to extract coordinate data of corresponding cutting start and end points, as will be described later. The RAM 63 has another storage area for sorting coordinate data, which area will be referred to as “sorting buffer” to be distinguished from the aforementioned data buffer.

When the rectangle is cut by the cutting apparatus 1, the holding sheet 10 (the object 6) is moved in the Y direction by the first moving unit 7 and the cutter holder 5 is moved in the X direction by the second moving unit 8, so that the cutter 4 is moved to x-Y coordinate of cutting start point P₀ of the line segment A1. Subsequently, the blade edge 4c of the cutter 4 is caused to penetrate through the object 6 at the cutting start point P₀ by the third moving unit 44. The object 6 and the cutter 4 are moved by the respective first and second moving units 7 and 8 relative to each other so that the blade edge 4c is moved the coordinate of the end point P₁ of the line segment A1, whereby the object 6 is cut along the line segment A1. The next line segment A2 is continuously cut with the end point P₁ of the previous line segment A1 serving as a start point in the same manner as the line segment A1. Line segments A2 to A4 are also cut sequentially continuously, whereby the cutting line of the rectangle is cut out of the object 6.

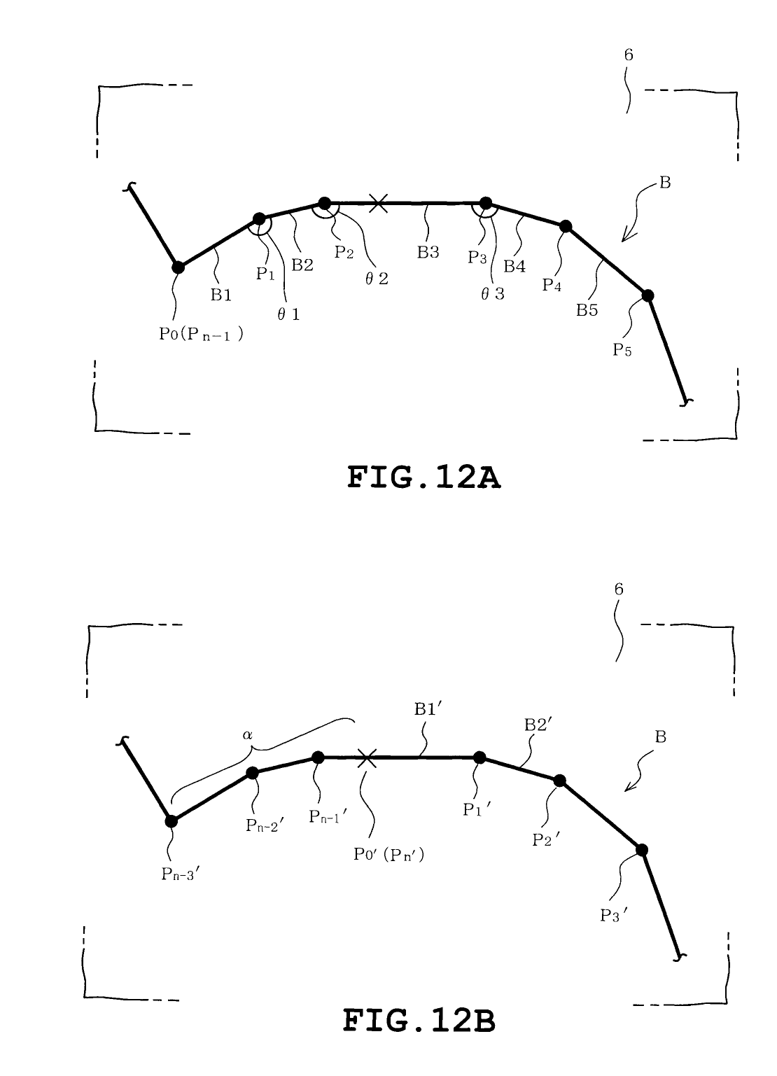

The ROM 62 stores a threshold T of a cutting angle θ that is an angle made between neighboring line segments composing the cutting line and is set to be smaller than 180 degrees. Furthermore, the threshold T is a value set relative to the cutting angle θ and at a predetermined value (130 degrees, for example). Furthermore, the control circuit 61 computes the cutting angle θ based on three consecutive coordinate point data on the cutting line as will be described in detail later. The control circuit 61 then compares the result of computation with the threshold T, thereby specifying a consecutive obtuse angle region (see FIGS. 12A and 128) where an obtuse angle that is equal to or larger than the threshold T is consecutive.

An amount of stretch correction is set according to a material of the object 6 (stretch properties). The ROM 62 stores a stretch correction table of correspondence relationship between the stretch correction amount and a type of the object 6. The stretch correction amount refers to an amount of correction movement by which an amount of relative movement between the cutter 4 and the object 6 is slightly increased in order that wrong cut due to a slight stretch of the object 6 may be prevented. Various materials are used for the object 6 as described above. Of clothes, felt is set at a relatively larger value of stretch correction amount, for example, whereas denim is set at a relatively smaller value of stretch correction amount, for example. When the object 6 is cut by the cutting apparatus 1, the user operates the operation switches 65 to enter a type of the object 6. The control circuit 61 then refers to the stretch correction table to specify a stretch correction amount corresponding to the entered type of the object 6. The user may operate the operation switches 65 to directly enter a numeric value of stretch correction amount, instead, for example.

The cutting start and end points are normally set at respective specified positions (see P₀ and P₄ in FIG. 11) such as the apex of the neighboring line segments on the cutting line, as described above. This results in a problem that part of the object 6 remains uncut or the object 6 is excessively cut as described above. In view of the problem, the control circuit 61 is configured to change the cutting start and end points to positions on the cutting line other than the specified positions by the software configuration of the cutting apparatus 1 (execution of the cutting data processing program). More specifically, the control circuit 61 serving as a calculation unit calculates the lengths of line segments composing the cutting line, based on the coordinate point data. In the case of a figure having points P₀, P₁, . . . , Pᵢ, Pᵢ₊₁ corresponding to coordinate data, a distance L of a line segment with Pᵢ (Xᵢ, Yᵢ) as a start point and the next Pᵢ₊₁ (Xᵢ₊₁, Yᵢ₊₁) as an end point is calculated by the following equation (1):

L=[(Xᵢ₊₁−Xᵢ)²+(Yᵢ₊₁−Yᵢ)]^{1/2} (1)

When the obtained length L is not less than a predetermined length (more than twice the stretch correction amount, for example), the control circuit 61 sets a middle point of the corresponding line segment as the cutting start and end points. In this case, the X and Y coordinates are represented by the following equations (2) and (3) respectively:

X=(Xᵢ+X₁₊₁)/2 (2)

Y=(Yᵢ+Yᵢ₊₁)/2 (3)

On the other hand, when all the line segments composing the cutting line have respective lengths less than the predetermined length, the control circuit 61 determines whether or not the cutting line includes a successive obtuse angle region where the aforementioned obtuse angle is successive. When the cutting line includes the successive obtuse angle region, the control circuit 61 sets new cutting start and end points on a line segment within the successive obtuse angle region. Thus, the control circuit 61 changes the position of the cutting start and end points to the position on the cutting line other than the specified position. More specifically, the control circuit 61 is configured as a setting unit.

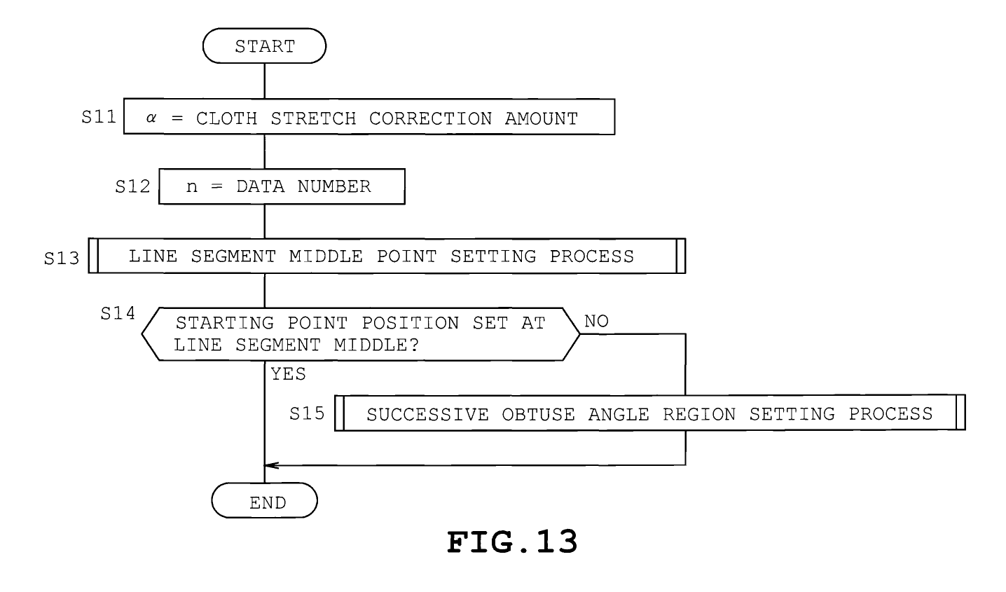

The following will describe a concrete processing procedure for positional change of the cutting start and end points with reference to FIGS. 13 to 17, which show processing flow of the cutting data processing program executed by the control circuit 61. Firstly, when the user selects cutting data of a desired pattern from the cutting data stored in the external memory 64, the selected cutting data is read from the external memory 64 to be expanded to the memory of the RAM 63. Furthermore, the user operates the operation switches 65 to enter a type of the object 6 (“denim”, for example). As a result, the control circuit 61 refers to the stretch correction table to specify a stretch correction amount α corresponding to the entered “denim” (step S11).

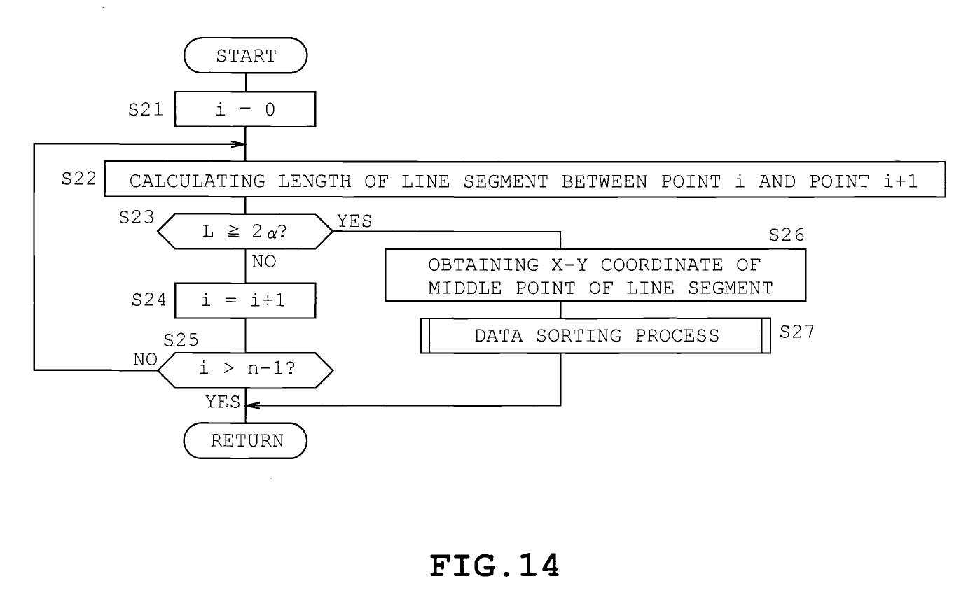

The control circuit 61 further refers to the read cutting data to obtain the number n of coordinate data (step S12). In the case of the cutting data of the cutting line A in FIG. 11A, for example, the number n of data is set at “5” obtained by counting from the cutting start point P₀ to the cutting end point P₄ as described above. The control circuit 61 then proceeds to step S13 where a middle point setting process is executed for the purpose of setting cutting start and end points on the middle point of the line segment (see FIG. 14). More specifically, the control circuit 61 sets cutting number i corresponding to the cutting order of apex P4 at 0 in order to obtain the length of a line segment between the apex of the cutting start point (i=0) and the next apex (i+1), at step S21. Since the cutting start and end points P₀ and P₄ correspond with each other, the cutting number i and the data number n bear the relationship of (i=0, 1, 2, . . . n−1).

The control circuit 61 then calculates the length L of line segment A1 from the apex P₀ (X₀, Yₒ) of the cutting start point to (X₁, Y₁) using equation (1) (step S22). The control circuit 61 then determines whether or not the obtained length L of the line segment A1 is not less than a predetermined length (more than twice the stretch correction amount α, for example) (step S23). The control circuit 61 updates the cutting number i to i=i+1 (step S24) every time determining that the length L is less than twice the stretch correction amount (NO). Regarding line segment. A2 (NO at step S25), too, the length L from apex P₁ (X₁, Y₁) to apex P₂ (X₂, Y₂) is calculated from equation (1) (step S22). Thus, steps S21 to S25 are repeated so that the lengths L of line segments A2 to A4 are calculated, and the control circuit 61 determines whether or not each obtained length L is not less than the predetermined length (step S23).

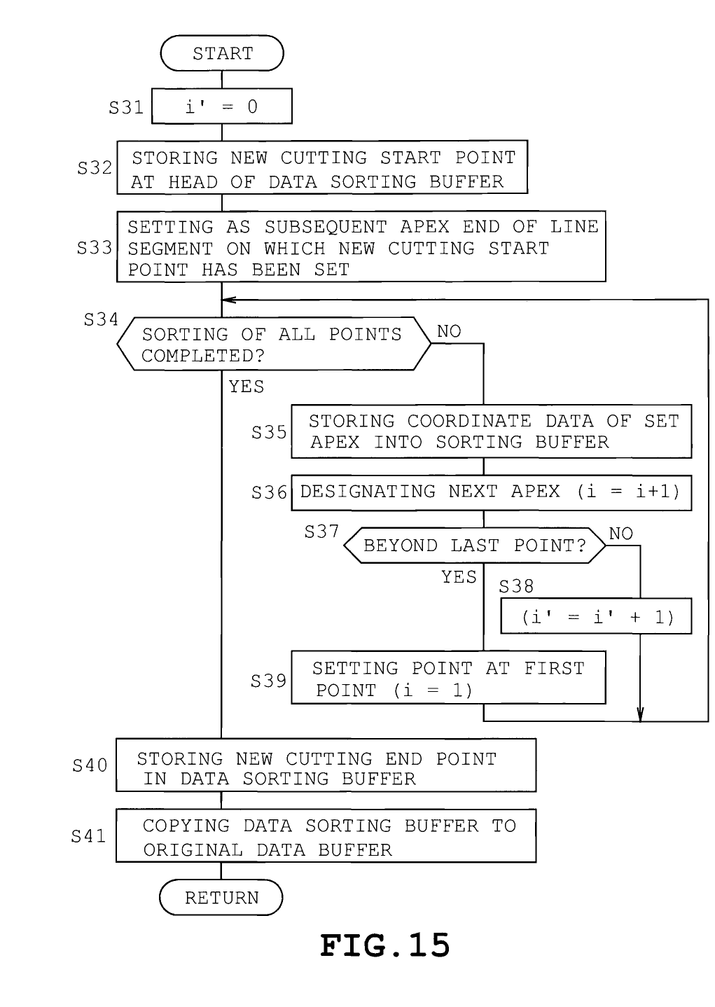

For example, when determining at step S23 that the length L of line segment A2 is at or above the predetermined length (YES), the control circuit 61 obtains X and Y coordinates of a middle point of the line segment A2 from equations (2) and (3) respectively (step S26). Subsequently, the control circuit 61 proceeds to step S27 to execute a data sorting process or a cutting sequence changing process in order to use the middle point of line segment A2 as the cutting start and end points (see FIG. 15).

In the data sorting process, the control circuit 61 sets at 0 cutting number i′ corresponding to the cutting sequence of the cutting data in a sorting buffer of RAM 63 (step S31). The position of the cutting start point P₀′ (see FIG. 11B) of cutting number 0 is set at the value calculated at step S26 (step S32). As a result, coordinate point data of the middle point of line segment A2 is stored at the head of the sorting buffer. Furthermore, the end point P₂ of line segment A2 on which the cutting start point P₀′ has been set is designated as an apex corresponding to P₁′ subsequent to P₀′ (step S33). More specifically, cutting number i′ is updated to i=I′+1, whereas the aforesaid cutting number i′ is updated to “2” corresponding to apex P₂. Regarding P₁′ (NO at step S34) following P₀′, coordinate point data of the designated P₂ is stored (step S35).

Subsequently, the control circuit 61 updates cutting number to i=i+1 and designates the next apex P₃ (step S36) and also determines whether or not the apex P₃ has went beyond the original cutting end point P₄ (that is, whether or not i≧n−1) (step S37). In this case, apex P₃ has not went beyond the original cutting end point P₄ (NO). Accordingly, apex P₃ is treated as corresponding to P₂′ the cutting number of which has been updated to i′=i′+1 (step S38 and NO at step S34). As a result, coordinate point data of designated P₃ is stored regarding P₂′ (step S35). Thus, the control circuit 61 repeats steps S34 to S38 until determining that cutting number i of Pᵢ has went beyond cutting end point P₄ (YES at step S37). Consequently, coordinate data of apexes P₂, P₃ and P₄ are sequentially written onto apexes P₁′, P₂′ and P₃′ following the P₀′ at the head of the sorting buffer, whereby data of apexes P₂ to P₄ are sorted.

Data of apex P₁ needs to be sorted even when the control circuit 61 has sorted data up to the original cutting end point P4 and has determined in the affirmative (YES) at step S37. For this purpose, the cutting number i of apex P₁ is set at “1” (step S39) and apex P₁ is sorted in the same manner as the above-described apexes P₂ to P₄ (NO at step S34; and step S35). Thus, the control circuit 61 repeats steps S34 to S38 until determining that data of all the apexes P₁ to P₄ have been completed (YES at step S34).

When determining at step S34 that the sorting of all the apexes P₁ to P₄ has been completed (YES), the control circuit 61 writes the coordinate point data obtained at step S26 to new cutting end point P₅′ (step S40). Data of data buffer of RAM 63 is rewritten into coordinate data of P₁′ to P₅′ stored in the sorting buffer thereby to be updated (step S41). Thus, the line segment middle point setting process is completed (returning to step S14 in FIG. 13).

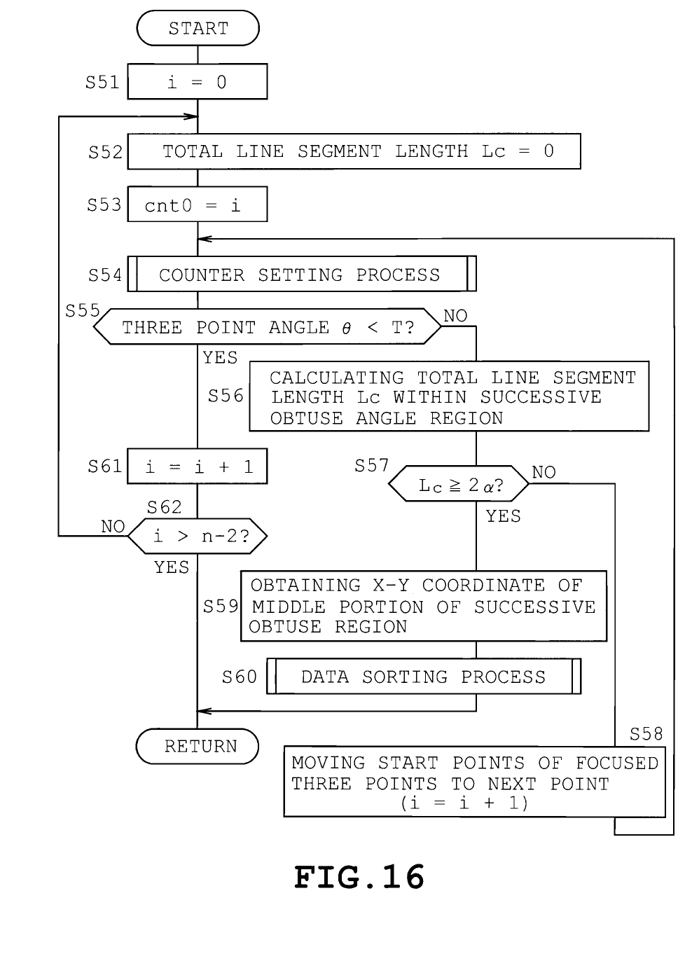

The entire processing is completed when the cutting start and end points are set at the middle point of the line segment (YES at step S14), as described above. On the other hand, when determining that the lengths of all the line segments composing the cutting line are less than the predetermined length (YES at step S25 in FIG. 14), the cutting start and end points are still located on the specified position (NO at step S14 in FIG. 13). In this case, the control circuit 61 proceeds to step S15 to execute a successive obtuse angle region setting process to set new cutting start and end points on a line segment within a successive obtuse angle region (see FIG. 16).

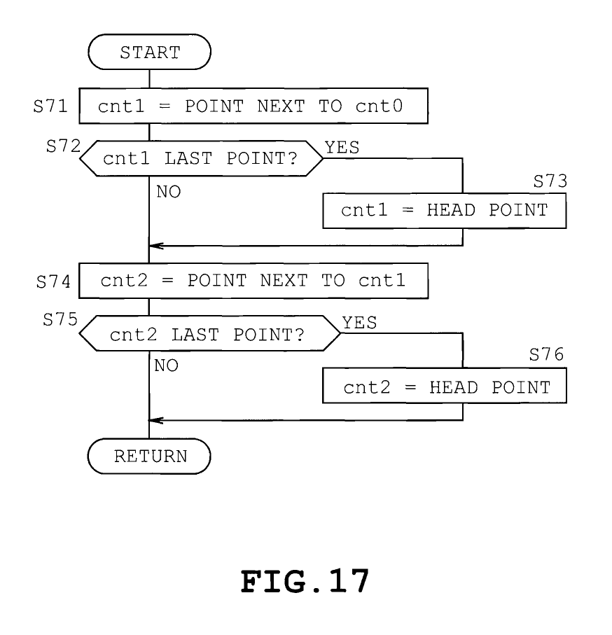

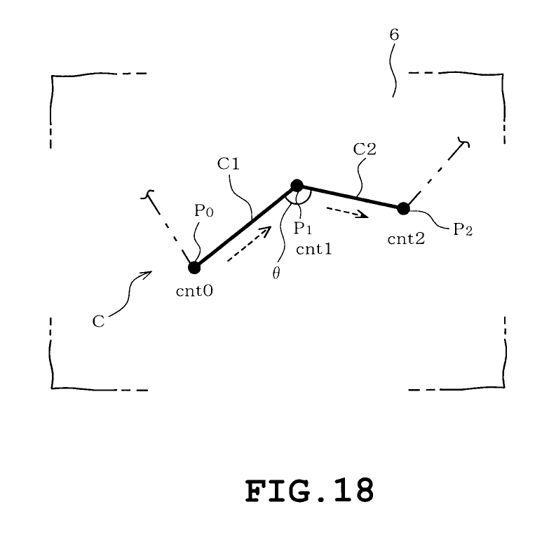

In the successive obtuse angle setting process, the control circuit 61 firstly sets cutting number i at 0 in order to obtain an angle (cutting angle) θ made between a first line segment with a cutting start point serving as a start point (i=0) and a second line segment next to the first line segment (step S51). The control circuit 61 further initializes a total line segment length Lc in the successive obtuse angle region to 0 (step S52) and updates a counter cnt0 (see FIG. 18) counting the start and end points of the line segment to the value of current cutting number i (step S53). The control circuit 61 then proceeds to step S54 to sequentially set the counters cnt0 to cnt2 pertinent to calculation of angle θ (a counter setting process; and see FIG. 17). In the counter setting process, the counter cnt1 is set to cnt1=cnt0+1 at step S71. Furthermore, the counter cnt2 is set to cnt2=cnt1+1 at step S72. At step S72 or S75, the control circuit 61 determines whether or not the count of the counter cnt1 or cnt2 corresponds with the cutting number at the time of cutting end point. When the count of the counter cnt0 is zero, the counts of counter cnt1 and cnt2 are 1 and 2 respectively. Accordingly, the control circuit 61 determines in the negative at step S72 or S75 as will be described later (returning to step S55).

At step S55, the control circuit 61 then calculates angles θ made by three points P₀ to P₂ corresponding to counts 0 to 2 of the counters cnt0 to cnt2 respectively. For example, when the object 6 is cut from the left apex P₀ sequentially to apexes P₁/P₂, . . . on the cutting line C as shown in FIG. 18, for example, the control circuit 61 computes an angle θ made between a line segment C1 between apexes P₀ and P₁ and a line segment C2 between apexes P₁ and P₂, based on coordinate data of the line segments. The control circuit 61 determines whether or not the angle θ obtained by the computation is less than a threshold T. When the angle θ is not less than the threshold T (NO at step S55), the control circuit 61 calculates the length of line segment C1 with a lower count out of the paired line segments C1 and C2. More specifically, the control circuit 61 calculates the distance between apexes P₀ and P₁ from equation (1) thereby to obtain the length to the apex of the corresponding corner as a total line segment length Lc within the successive obtuse angle (step S56). Furthermore, the control circuit 61 determines whether or not the calculated total line segment length Lc is equal to or larger than a predetermined length (twice or above stretch correction amount α, for example) (step S57).

When determining that the total line segment length Lc is less than twice or above stretch correction amount α (NO at step S57), the control circuit 61 updates cutting number i to i=i+1 (step S58). The control circuit 61 proceeds to the counter setting process at step S54 again to determine regarding the next apex P₂ (see FIG. 17). A cutting line B (see FIGS. 12A and 12B) will be exemplified in the following description. The cutting line B has a successive obtuse angle region where obtuse angles are successive as in the cutting line C.

In the counter setting process, the control circuit 61 increments the counters cnt1 and cnt2 by 1 at steps S71 and 74 respectively, as described above, thereafter returning to step S55. At step S55, the control circuit 61 computes an angle θ₂ made between line segments B2 and B3, regarding apexes P₁ to P₃ corresponding to count values 1 to 3 of the counters cnt0 to cnt2, based on coordinate data of the line segments, respectively. When determining that the obtained angle θ₂ is an obtuse angle not less than the threshold T (NO at step S55), the control circuit 61 calculates the length of line segment B2 with a lower count value out of the paired line segments B2 and B3. The control circuit 61 then updates the total line segment length Lc within the successive obtuse angle region to the total of the line segment length obtained by addition of the calculated length of line segment B2 and previously obtained line segment length Lc (B1) (step S56). When obtuse angles are successive (NO at step S55), the control circuit 61 repeats steps S54 to S58 in order of cutting number i until determining that the total line segment length Lc is twice or above the stretch correction amount α (YES at step S57). Furthermore, the line segment length calculated at step S56 is added to the total line segment length Lc thereby to be updated every time the counters cnt0 to cnt2 are incremented. The counter cnt1 is cleared to 0 when incremented until the count value corresponds with the cutting number at a cutting end point (YES at step S72; and step S73). The counter cnt2 is also cleared to 0 when the count value corresponding with cutting number at the cutting end point in the same manner as the counter cnt1 (YES at step S75; and step S76). As a result, since the counters cnt1 and cnt2 are set so as to correspond to the cutting number at the cutting start point, the successive obtuse angle region can be specified over the whole length (whole circumference) of the cutting line without a break.

When the total line segment length Lc of successive obtuse angle region is twice or above the stretch correction amount α (YES at step S57), the control circuit 61 sets the cutting start and end points to the line segment within the specified successive obtuse angle region (steps S59 and S60). More specifically, at step S59, the control circuit 61 obtains an X-Y coordinate of the located obtained by moving from the start point of the successive obtuse angle region along the line segment by a stretch correction amount. Accordingly, since each of the apexes θ₁, θ₁ and θ₃ is an obtuse angle on the cutting line as shown in FIGS. 12A and 12B, the control circuit 61 then obtains an X-Y coordinate of the position shown by symbol “x” distant by a from apex P0. The control circuit 61 further proceeds to step S60 to execute a data sorting process to set the position “x” to new cutting start and end points. In the data sorting process, steps S31 to S4 are executed in the same manner as the data sorting process at step S27 (see FIG. 15). As a result, the cutting start and end points changed to the positions P₀′ ad Pₙ′ obtained at step S59 are stored in the sorting buffer of the RAM 63 (steps S32 and S40). Furthermore, regarding apexes P₁ to Pₙ₋₁ in FIG. 12A, data sorted as shown as P₁′ to Pₙ₋₁′ is stored (steps S33 to S39). Data of the data buffer of RAM 63 is rewritten into coordinate data of P₀′ to Pₙ′ stored in the sorting buffer thereby to be updated (step S41). Thus, the control circuit 61 completes the successive obtuse angle region setting process and accordingly the whole processing.

The control circuit 61 repeats steps S52 to S55, S61 and S62 when two or more obtuse angles are not successively detected in the successive obtuse angle region setting process. When no successive obtuse angle region is on the cutting line (YES at step S62), the whole processing is completed without change in the cutting start and end points.

In the foregoing description, the cutting data processing program has been explained based on the premise that the cutting start and end points are located at the specified position. Accordingly, before step S11, the control circuit 61 determines whether or not the cutting start and end positions correspond with each other at the specified position, based on the cutting data, for example. When determining that the cutting start and end positions correspond with each other, the control circuit 61 executes the above-described cutting data processing program. The above-described steps S12, S21 to S27, S31 to S41 and S51 to S62 serve as an extraction routine to extract the positions of the cutting start and endpoints on the cutting line and also as a setting routine to change the positions of the cutting start and end points to a position on the cutting line other than the specified position.

The cutting apparatus constructed and configured as described above will work as follows. The cutter holder 5 is located at the raised position (see FIG. 5) before start of the cutting of the object 6 by the cutting apparatus 1. In this state, the user affixes the object 6 to the adhesive layer 10a so that the object 6 is held on the holding sheet 10. The holding sheet 10 is then set from the opening 2a of the cutting apparatus 1. The user then selects cutting data in which the positions of the cutting start and end points have been changed regarding the cutting line A as described above, for example. Upon operation of the operation switches 65, the control circuit starts a cutting operation based on the operation signals.

In the cutting operation, the Y-axis and X-axis motors 15 and 26 are driven so that the blade edge 4c of the cutter 4 is moved to the cutting start point P₀′ of the object 6 (see FIG. 11). When the cutter 4 has been moved to the cutting start point P₀′, the solenoid 57 is driven so that the pressing portion 56 presses the object 6. Furthermore, the Z-axis motor 34 is driven to move the cutter holder 5 to the lowered position and to cause the blade edge 4c to pass through the object 6 at the cutting start point P₀′. The cutter 4 is then moved toward the coordinate of the apex P₁′ by the drive of the Y-axis and X-axis motors 15 and 26 relative to the object 6, so that the object 6 is cut along the line segment A₁′. The line segment A2 is consecutively cut as the apex P₁′ of the previous line segment A1 serving as a start point in the same manner as the line segment A1. The consecutive cutting is sequentially executed regarding line segments A2′ to A5′, whereby the cutting line A of the “rectangle.”

In completing the cutting, the control circuit 61 executes the position correction of the cutting end point P₅′ so that uncut part is prevented. More specifically, the motors 15 and 26 are controlled so that the blade edge 4c is moved by stretch correction amount α on the extension of line segment A5′ beyond the cutting end point P₅′. In this case, the corrected cutting end point P₅′ added with correction amount α is on the line segment A1′. More specifically, the cutting lines are overlapped between cutting start point P₀′ and corrected cutting position P₅′. As a result, uncut part is prevented.

The cutting line B having corrected cutting start and end points is also cut so as not to have uncut part in the same manner as described above. More specifically, mark “x” serving as new cutting start and end points P₀′ and Pₙ′ is located on line segment B₁′ within the successive obtuse angle region, as shown in FIG. 12B. In this case, a corrected cutting end point Pₙ′ added with stretch correction amount α is shifted rightward by the stretch correction amount α relative to cutting start point P₀′. In other words, cutting lines are overlapped between cutting start point P₀′ and corrected cutting end point Pₙ′. As a result, uncut part can be prevented.

In the cutting, the object 6 can be pressed by the contact portion 56f driven by the solenoid 57 and can be held by the adhesion of the adhesive layer 10a on the holding sheet 10 so as not to be shifted. Furthermore, the pressing member 56 is moved relative to the object 6 during the cutting. However, since the contact portion 56f of the pressing member 56 is made of a material with a lower friction coefficient than the object 6, a frictional force generated between the contact portion 56f and the object 6 can be reduced as much as possible. This can prevent the shift of the object 6 resulting from the frictional force, whereupon an accurate cutting line can be formed.

The control circuit 61 serves as the extraction unit and the setting unit as described above. The control circuit extracts from the cutting data the positions of the cutting start and end points on the cutting line in the extraction routine. The control circuit 61 changes the positions of the cutting start and end points to the position on the cutting line other than the specified position in the setting routine. According to this, the cutting start and end points located at the specified position are changed to the position on the cutting line other than the specified position by the setting unit. Since the cutting start and end points are still on the cutting line after position change by the setting unit, the object 6 can be prevented from being excessively cut and can be cut without uncut part.

The setting unit sets the cutting start and end positions at the middle position P₀′ (P₅′) of any one A2 of the plural line segments A1 to A4. According to this, even when moved excessively over the cutting end point P₅′, the cutter 4 is moved along the original line segment A2, whereupon the object 6 is prevented from being excessively cut.

The setting unit sets the cutting start and end points at the line segment within the successive obtuse angle region in which angle θ made between neighboring line segments is not less than the threshold T. Accordingly, even when the cutter 4 is moved excessively over the cutting end point Pₙ′, the object 6 can be prevented from being excessively cut.

The setting unit executes the position correction in which the cutting line is extended so as to overlap along the line segment on which the cutting start and endpoints have been set. The position correction may be executed with respect to the cutting start point, instead of the cutting end point. As a result, since the cutting line is extended so as to overlap along the line segment, uncut part between the cutting start and end points can reliably be prevented.

The control circuit 61 serves as the calculation unit and executes the calculation routine to calculate the lengths of the plural line segments A1 to A4 (see step S22). The control circuit 61 is configured to set, in the setting routine, the cutting start and end points regarding line segment A2 out of the plural line segments A1 to A4 calculated in the calculation routine. Consequently, execution of the position correction can prevent the object 6 from being excessively cut even when the cutter 4 is moved excessively over the cutting end point P₅′.

Step S56 serves as the calculation routine to calculate the lengths of line segments B1 when calculating a total line segment Lc within the successive obtuse angle region. Thus, the cutting start and end points can be set at a suitable position on the basis of the result of calculation at the calculation routine even in the case of the cutting line including the successive obtuse angle region.

### Second Embodiment

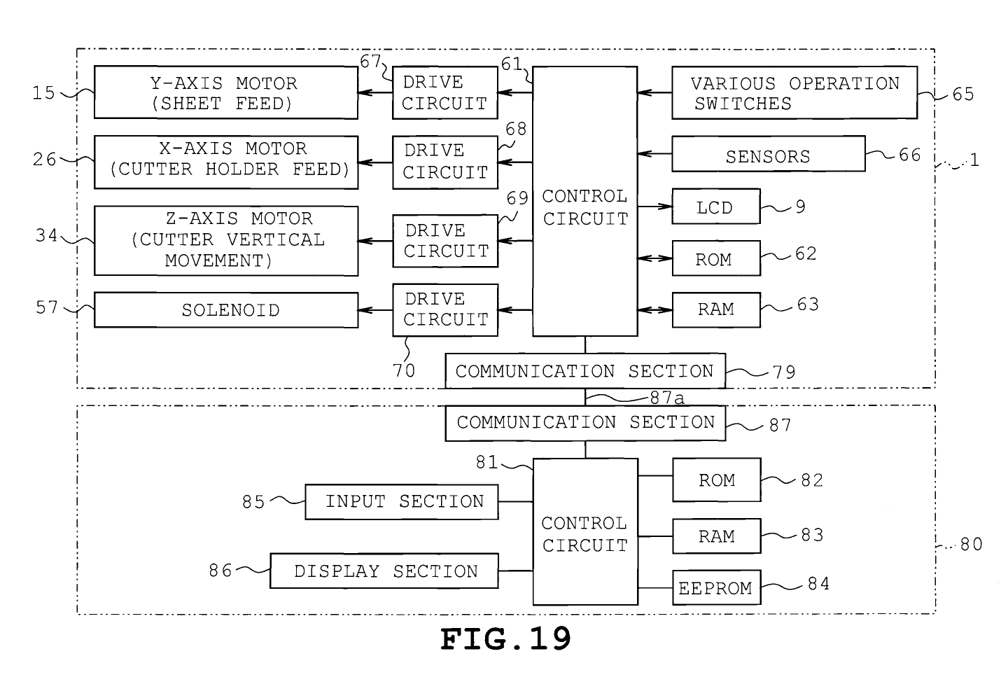

FIG. 19 illustrates a second embodiment. Only the difference between the first and second embodiments will be described. Identical or similar parts other than the aforementioned patterns in the second embodiment are labeled by the same reference symbols as those in the first embodiment.

A personal computer (hereinafter, referred to as “PC 80”) as shown in FIG. 19 is, configured as a cutting data processing device for processing the cutting data. More specifically, the PC 80 includes a control circuit 81 mainly constituted by a computer (CPU). A ROM 82, a RAM 83 and EEPROM 84 are connected to the PC 80. To the PC 80 is further connected an input section 85, such as a keyboard and a mouse, which is operated by the user in order that various instructions and selection may be entered and other input operations may be performed. A display section 86 (LCD, for example) is connected to the PC 80 to display messages or the like necessary for the user.

The PC 80 is provided with a communication section 87 which connects the PC 80 by wire or in a wireless manner to the cutting apparatus 1. The communication section 87 is connected via a cable 87a to a communication section 79 of the cutting apparatus 1. As a result, data including the cutting data is communicated between the PC 80 and the cutting apparatus 1. The control circuit 81 (control unit) controls the entire control and executes the cutting data processing program and the like. The ROM 82 stores the cutting data processing program, the threshold T, stretch correction table and the like. The RAM 83 temporarily stores data and programs necessary for various processing and has memory areas to store the frame cutting data, the boundary cutting data and the like. The EEPROM 84 stores various pattern cutting data.

The control circuit 81 reads the pattern cutting data from the EEPROM 84 and executes processing of the cutting data processing program, that is, the processing as shown by the flowcharts of FIGS. 13 to 17. As a result, the positions of the cutting start and end points are changed to a position on the cutting line other than the specified position in the same manner as in the first embodiment. The changed cutting data is overwritten onto the EEPROM 84 such that data in the EEPROM 84 is updated.

The control circuit 81 is configured as the extraction unit and the setting unit as the control circuit 61 of the first embodiment. Accordingly, the cutting data can be changed into data on which the object 6 can be cut without excessive cutting and without uncut part, and thus the second embodiment can achieve the same advantageous effects as the first embodiment.

The embodiments described above with reference to the drawings should not be restrictive but may be modified or expanded as follows. Although the cutting apparatus 1 is applied to the cutting plotter in each embodiment, the cutting apparatus 1 may be applied to various devices and apparatuses each having a cutting function.

The control circuit 61 executes the position correction of the cutting end point to prevent uncut part in the cutting and further controls so that the cutting lines overlap. These operations of the control circuit 61 should not be restrictive. More specifically, when a new cutting start point and a new cutting end point are set in the processing of the cutting data processing program, data of the corrected cutting end point is stored, instead of step S40, for example. According to this, although the cutting start and end points of the cutting data do not correspond with each other as the result of position correction, these points are on the original cutting line. Accordingly, the second embodiment can achieve the same advantageous effects as the first embodiment.

The cutting apparatus 1 is provided with a function of the cutting data processing device. The cutting data processing program stored in the cutting apparatus 1 as the cutting data processing device in a storage unit of PC80 may be stored in a computer-readable storage medium such as a USB memory, a CD-ROM, a flexible disc, a DVD or a flash memory. In this case, when data and a program may be read from the storage medium, the second embodiment can achieve the same advantageous effects s the first embodiment.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed is:

1. A cutting apparatus which moves a cutting blade and an object to be cut relative to each other based on cutting data, thereby cutting a desirable pattern out of the object, the cutting apparatus comprising:
an extraction unit which extracts from the cutting data a position of a cutting start point and a position of a cutting end point of a cutting line on the object; and
a setting unit which changes the positions of the cutting start and end points to a position on the cutting line other than a specified position on the cutting line when the positions of the cutting start and endpoints extracted by the extraction unit are on the specified position in a case where a closed pattern having the cutting start and endpoints corresponding with each other is cut out of the object.

2. The apparatus according to claim 1, wherein the cutting line includes a plurality of continuing line segments, and the setting unit sets the cutting start and end points at a middle position on one of the line segments.

3. The apparatus according to claim 1, wherein the cutting line includes a plurality of continuing line segments, and the setting unit sets the cutting start and end points at the line segment within a successive obtuse angle region where an obtuse angle that is an angle made between neighboring line segments and being not less than a threshold is successive.

4. The apparatus according to claim 2, wherein the setting unit executes a position correction in which the cutting line is extended so as to overlap along the line segment on which the cutting start and end points have been set, whereby an occurrence of an uncut part of the object is prevented.

5. The apparatus according to claim 2, wherein the setting unit includes a calculation unit which calculates lengths of the plural line segments, and the cutting start and end points are set on one of the line segments having a length that is not less than a predetermined value.

6. A cutting data processing device for use with a cutting apparatus which moves a cutting blade and in object to be cut relative to each other based on cutting data, thereby cutting a desirable pattern out of the object, the device comprising:
an extraction unit which extracts from the cutting data a position of a cutting start point and a position of a cutting end point of a cutting line on the object; and
a setting unit which changes the positions of the cutting start and end points to a position on the cutting line other than a specified position on the cutting line when the positions of the cutting start and end points extracted by the extraction unit are on the specified position in a case where a closed pattern having the cutting start and end points corresponding with each other is cut out of the object.

7. The device according to claim 6, wherein the cutting line includes a plurality of continuing line segments, and the setting unit sets the cutting start, and end points at a middle position on one of the line segments.

8. The device according to claim 6, wherein the cutting line includes a plurality of continuing line segments, and the setting unit sets the cutting start and end points at the line segment within a successive obtuse angle region where an obtuse angle that is an angle made between neighboring line segments and being not less than a threshold is successive.

9. The device according to claim 7, wherein the setting unit executes a position correction in which the cutting line is extended so as to overlap along the line segment on which the cutting start and end points have been set, whereby an occurrence of an uncut part of the object is prevented.

10. The device according to claim 7, wherein the setting unit includes a calculation unit which calculates lengths of the plural line segments, and the cutting start and end points are set on one of the line segments having a length that is not less than a predetermined value.

11. A storage medium which is computer-readable and stores a program that is used for a cutting apparatus which cuts a desired pattern out of an object to be cut by moving a cutting blade and the object, the program comprising:
an extraction routine of extracting from the cutting data a position of a cutting start point and a position of a cutting end point of a cutting line on the object; and
a setting routine of changing the positions of the cutting start and endpoints to a position on the cutting line other than a specified position on the cutting line when the positions of the cutting start and endpoints extracted by the extraction unit are on the specified position in a case where a closed pattern having the cutting start and end points corresponding with each other is cut out of the object.

12. The storage medium according to claim 11, wherein the cutting line includes a plurality of continuing line segments, and the setting unit sets the cutting start and end points at a middle position on one of the line segments.

13. The storage medium according to claim 11, wherein the cutting line includes a plurality of continuing line segments, and the setting unit sets the cutting start and end points at the line segment within a successive obtuse angle region where an obtuse angle that is an angle made between neighboring line segments and being not less than a threshold is successive.

14. The apparatus according to claim 12, wherein the setting unit executes a position correction in which the cutting line is extended so as to overlap along the line segment on which the cutting start and end points have been set, whereby an occurrence of an uncut part of the object is prevented.

15. The apparatus according to claim 12, wherein the setting unit includes a calculation unit which calculates lengths of the plural line segments, and the cutting start and end points are set on one of the line segments having a length that is not less than a predetermined value.
